(19) United States
(12) Patent Application Publication
(10) Pub. No.: US 2025/0305758 A1
(43) Pub. Date: Oct. 2, 2025

(54) REFRIGERATOR

(71) Applicant: SAMSUNG ELECTRONICS CO., LTD., Suwon-si (KR)

(72) Inventors: Hosang PARK, Suwon-si (KR); Seongwoo KIM, Suwon-si (KR); Ilsung BAE, Suwon-si (KR); Byoungjae CHO, Suwon-si (KR)

(73) Assignee: SAMSUNG ELECTRONICS CO., LTD., Suwon-si (KR)

(21) Appl. No.: 19/233,317

(22) Filed: Jun. 10, 2025

Related U.S. Application Data
(63) Continuation of application No. PCT/KR2023/017610, filed on Nov. 6, 2023.

(30) Foreign Application Priority Data
Jan. 4, 2023 (KR) 10-2023-0001428

(51) Int. Cl. F25D 23/02; E05D 11/00

(52) U.S. Cl. CPC F25D 23/028; E05D 11/0081; E05Y 2900/31; F25D 2323/024

(57) ABSTRACT

A refrigerator comprising a main body having a storage compartment; an inner door at the front of the main body, the inner door is rotatable about a hinge coupled to the main body; an outer door rotatable relative to a front of the inner door; a first wire connectable to a main body cable of the main body; a second wire connectable to the first wire where the second electric wire extends from the outer door to the inner door; and a hinge assembly arrangeable at the top of the inner door. The hinge assembly comprises: a hinge hole into which a hinge shaft of the hinge is rotatably insertable, and which guides the first cable; and a connection portion which is integrally formed with the hinge hole and has, formed therein, a connection space in which the first cable connects to the second cable.

### CROSS-REFERENCE TO RELATED APPLICATION

This application is a continuation application is a continuation application, under 35 U.S.C. § 111 (a), of international application No. PCT/KR2023/017610, filed Nov. 6, 2023, which claims priority under 35 U. S. C. § 119 to Korean Patent Application No. 10-2023-0001428, filed Jan. 4, 2023, the disclosures of which are incorporated herein by reference in their entireties.

### TECHNICAL FIELD

The present disclosure relates to a refrigerator in which an electric wire connection structure connecting a double door and a main body is improved.

### BACKGROUND ART

A refrigerator is a device that includes a main body having a storage compartment, and includes a cool air supply system for supplying cool air to the storage compartment to keep food fresh. The storage compartment may include a refrigerated compartment, which is maintained at approximately 0 to 5 degrees Celsius to store food in a refrigerated state, and a frozen compartment, which is maintained at approximately 0 to minus 30 degrees Celsius to store food in a frozen state. A door is provided on a front surface of the main body so as to open and close the storage compartment. The door is provided on the front surface of the main body to be rotatable so as to open and close the storage compartment.

In recent refrigerators, various electronic devices are additionally provided, and the refrigerators are being developed not only to perform their original functions but also in a direction to supplement and improve the functions of the refrigerators. The various electronic devices are provided on the door of the refrigerator, and the various electronic devices are electrically connected to a controller or power supply device provided in the main body via an electric wire.

### DISCLOSURE

### Technical Problem

An embodiment of the present disclosure provides a refrigerator having an improved connection structure of an electric wire connecting an electronic device provided on a door and a main body.

An embodiment of the present disclosure provides a refrigerator in which a connection space, to which the electric wire connecting an electronic device provided on a door and a main body is connected, is exposed to the outside of the door so that connection and/or disconnection of the electric wire may be facilitated.

An embodiment of the present disclosure provides a refrigerator capable of improving exterior quality by minimizing exposure of the electric wire after the electric wire, which connects an electronic device provided on a door and a main body, is connected.

An embodiment of the present disclosure provides a refrigerator in which a component for guiding a first electric wire, which passes through an inner door and is connected to a main body electric wire, to a connection space connected to a second electric wire connected to an outer door, is formed as a single component, thereby reducing material cost and shortening a manufacturing process.

Technical problems to be solved by this document are not limited to the above-mentioned technical problems, and other technical problems, which are not described above, may be clearly understood from the following descriptions by those skilled in the art to which the present disclosure pertains.

### Technical Solution

According to the concept of the present disclosure, a refrigerator may include a main body including a storage compartment, an inner door to be provided on a front surface of the main body and while provided on the front surface, the inner door is rotatable about a hinge coupled to the main body, an outer door rotatably provided on a front surface of the inner door, a first electric wire connectable to a main body electric wire of the main body to pass through the inner door, a second electric wire, connectable to the first electric wire, such that while the second electric wire is connected to the first electric wire, the second electric wire extends from the outer door to the inner door, and a hinge assembly to be arranged an upper portion of the inner door. The hinge may include a hinge hole into which a hinge shaft of the first hinge is rotatably insertable and which guides the first electric wire, and a connection portion integrally formed with the hinge hole and forming a connection space in which the first electric wire is connected to the second electric wire.

According to the concept of the present disclosure, a refrigerator may include a main body including a storage compartment, an inner door to be provided on a front surface of the main body and while provided on the front surface, the inner door is rotatable about a hinge into which a hinge shaft of a first hinge coupled to the main body is rotatably is insertable, an outer door rotatably provided on a front surface of the inner door by a second hinge coupled to the inner door, a first electric wire connectable to a main body electric wire of the main body and disposed to pass through the inner door, and a second electric wire, connectable to the first electric wire, such that while the second electric wire is connected to the first electric wire, the second electric wire extends from the outer door to the inner door. The hinge may include a hinge hole assembled to an upper portion of the inner door so that the hinge shaft is rotatably insertable and which guides the first electric wire, and a connection portion integrally formed with the hinge hole and forming a connection space in which the first electric wire is connected to the second electric wire. The second hinge may include a guide hinge coupled to the outer door so as to be connected to the connection portion and to guide the second electric wire to the connection space, and a hinge cover coupled to the inner door to cover an upper portion of the guide hinge.

### DESCRIPTION OF DRAWINGS

FIG. 1 is a perspective view of a refrigerator according to an embodiment.

FIG. 2 is a perspective view of the refrigerator with a door opened according to an embodiment.

FIG. 3 is an exploded view of the door of the refrigerator according to an embodiment.

FIG. 4 is an exploded view illustrating a portion of the configuration of the refrigerator according to an embodiment.

FIG. 5 is a view illustrating a hinge assembled to an inner door and a second hinge according to an embodiment.

FIG. 6 is an exploded view illustrating the hinge and the second hinge according to an embodiment.

FIG. 7 is a view illustrating a state in which a first electric wire and a second electric wire are connected in a connection space of the hinge assembled to the inner door according to an embodiment.

FIG. 8 is a cross-sectional view illustrating a state in which the first electric wire and the second electric wire are connected in the connection space of the hinge assembled to the inner door according to an embodiment.

FIG. 9 is a view illustrating a state in which an electric wire is connected as viewed from an upper portion of the door according to an embodiment.

### MODES OF THE INVENTION

Various embodiments of the present disclosure and the terms used in the embodiment are not intended to limit the technical features disclosed in the present disclosure to the particular embodiments and should be understood as including various alterations, equivalents, or alternatives of the corresponding embodiments.

In connection with the description of the drawings, the similar reference numerals may be used for the similar or relevant constituent elements.

The singular form of a noun corresponding to an item may include one or plurality of the items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

The term “and/or” includes a combination of a plurality of related constituent elements or any constituent element among the plurality of related constituent elements.

Such terms as “1st” and “2nd,” or “first” and “second” may be used to simply distinguish a corresponding constituent element from another, and does not limit the constituent elements in other embodiment (e.g., importance or order).

In addition, the terms such as “front surface,” “rear surface,” “upper surface,” “lower surface,” “side surface,” “left,” “right,” “upper portion,” and “lower portion” used in the present disclosure are defined based on the drawings, and the shapes and positions of respective constituent elements are not limited by these terms.

It should be understood the terms “comprises,” “comprising,” “includes,” “including,” “containing,” “has,” “having” or other variations thereof are inclusive and therefore specify the presence of stated features, integers, steps, operations, constituent elements, components, or combinations thereof disclosed in the present disclosure, but do not preclude the presence or addition of one or more other features, integers, steps, operations, constituent elements, components, or combinations thereof.

When a constituent element is said to be “connected,” “coupled,” “supported,” or “in contact” with another constituent element, this includes not only cases where the constituent elements are directly connected, coupled, supported, or in contact with each other, but also cases where they are indirectly connected, coupled, supported, or in contact through a third constituent element.

When a constituent element is said to be positioned “on” another constituent element, this includes not only cases where the constituent element is in direct contact with the other constituent element, but also cases where another constituent element exists between the two constituent elements.

An refrigerator according to an embodiment may include a main body.

The “main body” may include an inner case, an outer case disposed outside the inner case, and an insulation provided between the inner case and the outer case.

The “inner case” may include at least one of a case, plate, panel, or liner that forms a storage compartment. The inner case may be formed as a single body, or may be formed by assembling a plurality of plates. The “outer case” may form an exterior of the main body, and may be coupled to an outer side of the inner case such that the insulation is disposed between the inner case and the outer case.

The “insulation” may insulate between an inside and an outside of the storage compartment such that a temperature inside the storage compartment may be maintained at a set appropriate temperature without being affected by an external environment of the storage compartment. According to an embodiment, the insulation may include a foam insulation. The foam insulation may be formed by injecting and foaming a urethane foam, in which polyurethane and a foaming agent are mixed, between the inner case and the outer case.

According to an embodiment, the insulation may further include a vacuum insulation in addition to the foam insulation, or the insulation may be configured only of the vacuum insulation instead of the foam insulation. The vacuum insulation may include a core material, and an outer covering material that accommodates the core material and seals an inside under a vacuum or a pressure close to a vacuum. However, the insulation is not limited to the above-described foam insulation or vacuum insulation, and may include various materials that may be used for insulation.

The “storage compartment” may include a space defined by the inner case. The storage compartment may further include an inner case that defines a space corresponding to the storage compartment. In the storage compartment, various items such as food, medicine, and cosmetics may be stored, and the storage compartment may be formed such that at least one side is opened to store and take out the items.

The refrigerator may include one or more storage compartments. When two or more storage compartments are formed in the refrigerator, each storage compartment may have a different usage purpose and may be maintained at a different temperature. To this end, each storage compartment may be partitioned by a partition wall including insulation.

The storage compartment may be provided to be maintained within an appropriate temperature range according to a usage purpose, and may include a “refrigerated compartment”, a “frozen compartment”, or a “variable-temperature compartment”, which are distinguished according to the usage purpose and/or temperature range. The refrigerated compartment may be maintained at an appropriate temperature for preserving items in an refrigerated state, and the frozen compartment may be maintained at an appropriate temperature for preserving items in a frozen state. The term “refrigeration” may refer to cooling items within a range that does not freeze the items, and, for example, the refrigerated compartment may be maintained in a range of 0 degrees Celsius to 7 degrees Celsius. The term “freezing” may refer to cooling items to freeze the items or to maintain the items in a frozen state, and, for example, the frozen compartment may be maintained in a range of minus 20 degrees Celsius to minus 1 degree Celsius. The variable-temperature compartment may be used as either the refrigerated compartment or the frozen compartment according to a user's selection or regardless of the selection.

The storage compartment may be referred to by various names in addition to the terms “refrigerated compartment,” “frozen compartment,” “variable-temperature compartment,” and the like such as “vegetable compartment,” “fresh compartment,” “cooling compartment,” and “ice-making compartment,” and the terms “refrigerated compartment,” “frozen compartment,” “variable-temperature compartment,” and the like used hereinafter should be understood to encompass storage compartments having corresponding usage purposes and temperature ranges.

According to an embodiment, the refrigerator may include at least one door configured to open and close an open side of a storage compartment. The door may be provided to open and close one or more of the storage compartments respectively, or a single door may be provided to open and close a plurality of storage compartments. The door may be installed on a front surface of a main body to be rotatable or slidable.

The “door” may be configured to seal the storage compartment when the door is closed. The door may include an insulation, like the main body, to insulate the storage compartment when the door is closed.

According to an embodiment, the door may include a door outer panel that forms a front surface of the door, a door inner panel that forms a rear surface of the door and faces the storage compartment, an upper cap, a lower cap, and a door insulation provided inside these components.

A gasket may be provided on an edge of the door inner panel to seal the storage compartment by closely contacting a front surface of the main body when the door is closed. The door inner panel may include a dyke that protrudes rearward so that a door basket for storing items may be mounted.

According to an embodiment, the door may include a door body and a front panel that is detachably coupled to a front side of the door body and forms the front surface of the door. The door body may include a door outer panel that forms a front surface of the door body, a door inner panel that forms a rear surface of the door body and faces the storage compartment, an upper cap, a lower cap, and a door insulation provided inside these components.

The refrigerator may be classified into a french door type, a side-by-side type, a bottom mounted freezer (BMF), a top mounted freezer (TMF), a one-door refrigerator, or the like depending on the disposition of the door and the storage compartment.

According to an embodiment, the refrigerator may include a cool air supply device provided to supply cool air to the storage compartment.

The “cool air supply device” may include a machine, mechanism, electronic device, and/or a system combining them, which generates cool air and guides the cool air to cool the storage compartment.

According to an embodiment, the cool air supply device may generate cool air through a refrigeration cycle that includes compression, condensation, expansion, and evaporation of a refrigerant. To this end, the cool air supply device may include a refrigeration cycle device having a compressor, a condenser, an expansion device, and an evaporator that are capable of driving the refrigeration cycle. According to an embodiment, the cool air supply device may include a semiconductor such as a thermoelectric element. The thermoelectric element may cool the storage compartment by heating and cooling effects based on the Peltier effect.

According to an embodiment, the refrigerator may include a machine room provided to dispose at least some components belonging to the cool air supply device.

The “machine room” may be provided to be partitioned and insulated from the storage compartment to prevent heat generated by components disposed in the machine room from being transferred to the storage compartment. The interior of the machine room may be configured to communicate with the outside of the main body to release heat from the components disposed in the machine room.

According to an embodiment, the refrigerator may include a dispenser provided on the door to provide water and/or ice. The dispenser may be provided on the door to be accessible without opening the door by a user.

According to an embodiment, the refrigerator may include an ice making device provided to generate ice. The ice making device may include an ice making tray for storing water, an ice separating device for separating ice from the ice making tray, and an ice bucket for storing the ice generated in the ice making tray.

According to an embodiment, the refrigerator may include a controller for controlling the refrigerator.

The “controller” may include a memory that stores or memorizes a program and/or data for controlling the refrigerator, and a processor that outputs a control signal to control the cool air supply device and the like according to the program and/or data memorized in the memory.

The memory stores or records various information, data, instructions, programs, and others necessary for the operation of the refrigerator. The memory may memorize temporary data generated during the process of generating control signals to control the components included in the refrigerator. The memory may include at least one of volatile memory or non-volatile memory, or a combination thereof.

The processor controls the overall operation of the refrigerator. The processor may execute the program stored in the memory to control the constituent elements of the refrigerator. The processor may include a separate NPU for performing the operation of an artificial intelligence model. In addition, the processor may include a central processing unit, a graphics processing unit (GPU), and others. The processor may generate control signals to control the operation of the cool air supply device. For example, the processor may receive temperature information of the storage compartment from a temperature sensor and generate a cooling control signal to control the operation of the cool air supply device based on the temperature information of the storage compartment.

In addition, the processor may process user inputs to a user interface and control the operation of the user interface according to the program and/or data memorized/stored in the memory. The user interface may be provided using an input interface and an output interface. The processor may receive a user input from the user interface. In addition, the processor may transmit a display control signal and image data to the user interface to display an image on the user interface in response to the user input.

The processor and memory may be provided integrally or separately. The processor may include one or more processors. For example, the processor may include a main processor and at least one sub-processor. The memory may include one or more memories.

According to an embodiment, the refrigerator may include a processor and a memory for controlling all of the components included in the refrigerator, and may include a plurality of processors and a plurality of memories for individually controlling the components of the refrigerator. For example, the refrigerator may include a processor and a memory for controlling the operation of the cool air supply device according to an output of a temperature sensor. In addition, the refrigerator may separately include a processor and a memory for controlling the operation of a user interface according to a user input.

The communication module may communicate with external devices such as a server, a mobile device, and other home appliances through a surrounding access point (AP). The access point (AP) may connect a local area network (LAN), to which the refrigerator or a user device is connected, to a wide area network (WAN) connected to the server. The refrigerator or the user device may be connected to the server through the wide area network (WAN).

The input interface may include keys, a touchscreen, a microphone, and the like. The input interface may receive a user input and transmit the user input to the processor.

The output interface may include a display, a speaker, and the like. The output interface may output various notifications, messages, information, and the like generated by the processor.

Hereinafter, embodiments according to the present disclosure will be described in detail with reference to the attached drawings.

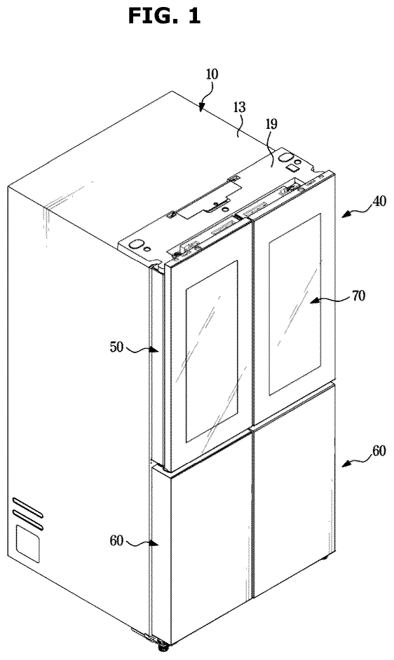

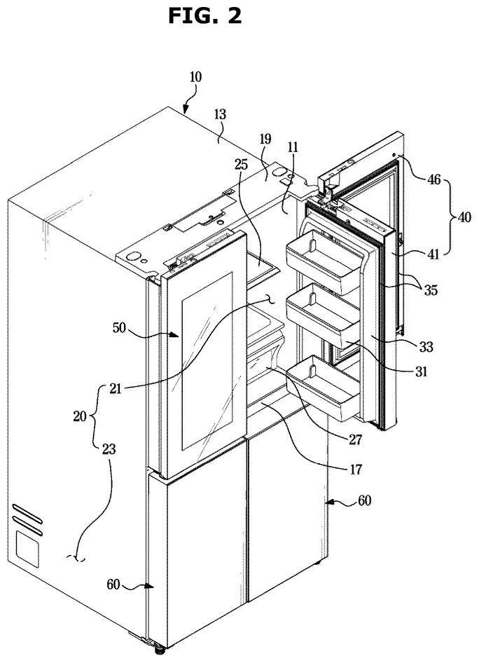

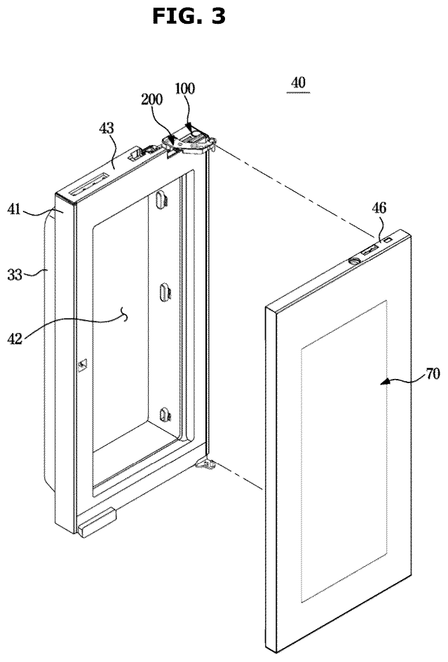

FIG. 1 is a perspective view of a refrigerator according to an embodiment. FIG. 2 is a perspective view of the refrigerator with a door opened according to an embodiment. FIG. 3 is an exploded view of the door of the refrigerator according to an embodiment.

As illustrated in FIGS. 1 to 3, the refrigerator may include a main body 10, a plurality of storage compartments 20 provided in the main body 10 so that front surfaces thereof are open, a door 30 for opening and closing the open front surfaces of the storage compartments 20, and a cool air supply device (not illustrated) for supplying cool air into the storage compartments 20.

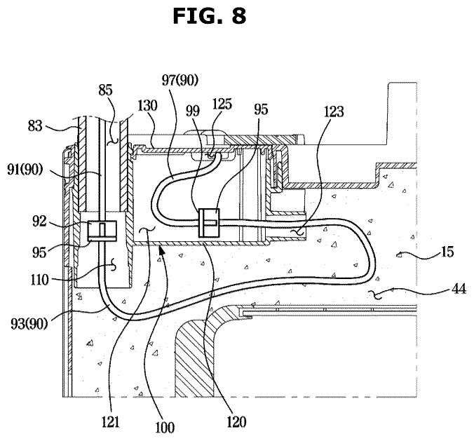

The main body 10 may include an inner case 11 for forming the storage compartments 20, and an outer case 13 for forming an exterior. An insulation 15 (see FIG. 8) may be foamed between the inner case 11 and the outer case 13, and inside the door 30, so as to prevent leakage of cool air from the storage compartments 20.

The main body 10 may include a cool air supply device for supplying cool air to the storage compartments 20. The cool air supply device may be configured to include a compressor, a condenser, an expansion valve, an evaporator, a blower fan, a cool air duct, and the like.

A machine room (not illustrated), in which the compressor and the condenser for compressing a refrigerant and condensing the compressed refrigerant are installed, may be provided in a rear lower portion of the main body 10.

The evaporator for generating cool air, the blower fan for guiding the cool air generated by the evaporator into the storage compartments 20, and a cool air duct for guiding the cool air generated by the evaporator into the storage compartments 20 may be disposed on a rear wall of the storage compartments 20. The evaporator, the blower fan, and the cool air duct may each be provided in plurality so that cool air may be independently supplied to the storage compartments 20.

The storage compartments 20 may be partitioned into an upper storage compartment 21 and a lower storage compartment 23 by a horizontal partition wall 17. The upper storage compartment 21 and the lower storage compartment 23, which are partitioned by the horizontal partition wall 17, may be used as a refrigerated compartment and a frozen compartment, respectively. However, the above-described partition and usage purpose of the storage compartments 20 are merely one example and are not limited thereto.

A plurality of shelves 25 may be provided in the storage compartments 20 to partition the interior of the storage compartments 20 into a plurality of sections. A plurality of storage containers 27 for storing food or the like may be provided in the storage compartments 20.

The door 30 may be rotatably coupled to the main body 10 so as to open and close the storage compartments 20. The door 30 may include a pair of refrigerated compartment doors 40 and 50 for opening and closing the upper storage compartment 21. The pair of refrigerated compartment doors 40 and 50 may include a first door 40 rotatably coupled to a front right side of the main body 10, and a second door 50 rotatably coupled to a front left side of the main body 10.

The door 30 may include a pair of frozen compartment doors 60 for opening and closing the lower storage compartment 23. In the drawings, the pair of frozen compartment doors 60 are illustrated as being rotatably coupled to the main body 10 so as to open and close the storage compartments 20, but this is not limited thereto. For example, the pair of frozen compartment doors 60 may be provided as a single sliding door.

A plurality of door baskets 31 for storing food or the like may be installed on a rear surface of the door 30. A dyke 33 that protrudes rearward to support the door baskets 31 may be formed on the rear surface of the door 30. A gasket 35 may be provided on the rear surface of the door 30 to seal the storage compartments 20 by being in close contact with a front surface of the main body 10 when the door 30 is closed.

The pair of refrigerated compartment doors 40 and 50 may each be configured as double doors including an inner door and an outer door. For convenience of description, a description will be given with reference to the first door 40, which is rotatably coupled to a front right side of the main body 10 among the pair of refrigerated compartment doors 40 and 50, and the first door 40 will be referred to as the door.

The door 40 may include an inner door 41 and an outer door 46. The inner door 41 may be rotatably provided on the front surface of the main body 10. The outer door 46 may be rotatably provided on a front surface of the inner door 41. The inner door 41 and the outer door 46 may together open and close a portion of a right side of the upper storage compartment 21. The above-mentioned door baskets 31, dyke 33, and gasket 35 may be formed on a rear surface of the inner door 41. The gasket 35 may also be formed on a rear surface of the outer door 46.

The inner door 41 may include a door opening 42. The outer door 46 may be rotatably provided on the front surface of the inner door 41 to open and close the door opening 42 of the inner door 41. Detailed configurations of the inner door 41 and the outer door 46 will be described below.

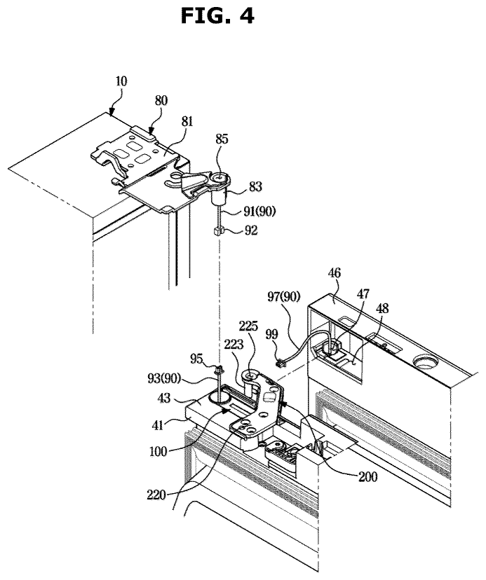

An display device 70, which is an electronic device, may be provided on the door 40. The display device 70 may be provided on a front surface of the door 40. The display device 70 may display various types of information related to a state or operation of the refrigerator, or may display various applications for user convenience. In the drawings, the electronic device provided on the door 40 is illustrated as the display device 70, but this is not limited thereto, and may be another electronic device. The display device 70 may be electrically connected to a controller (not illustrated) and/or a power supply device (not illustrated) provided in the main body 10 by an electric wire 90 (see FIG. 4).

A first hinge 80 for rotatably coupling the inner door 41 to the main body 10 may be coupled to the main body 10. The first hinge 80 may include a hinge bracket 81 and a first hinge shaft 83 formed in the hinge bracket 81. The hinge bracket 81 may be coupled to the main body 10.

The inner door 41 may be rotatably provided on the front surface of the main body 10 by the first hinge shaft 83 of the first hinge 80 coupled to the main body 10. The inner door 41 may rotate about the first hinge shaft 83. A hinge 100 into which the first hinge shaft 83 is rotatably inserted may be provided on an upper portion of the inner door 41. A detailed configuration of the hinge 100 will be described below. A top table 19 may be provided on an upper surface of the main body 10. The top table 19 may cover the first hinge 80 so that the first hinge 80 is not exposed to the outside.

A second hinge 200 for rotatably coupling the outer door 46 to the inner door 41 may be coupled to the inner door 41. The outer door 46 may be rotatably provided on the front surface of the inner door 41 by a second hinge shaft 223 of the second hinge 200 coupled to the inner door 41. The outer door 46 may rotate about the second hinge shaft 223. A rotation hole 47 into which the second hinge shaft 223 is rotatably inserted may be formed in the outer door 46. A hinge accommodating portion 48, into which a portion of the second hinge 200 is accommodated, may be formed in the outer door 46. The rotation hole 47 may be formed inside the hinge accommodating portion 48. A detailed configuration of the second hinge 200 will be described below.

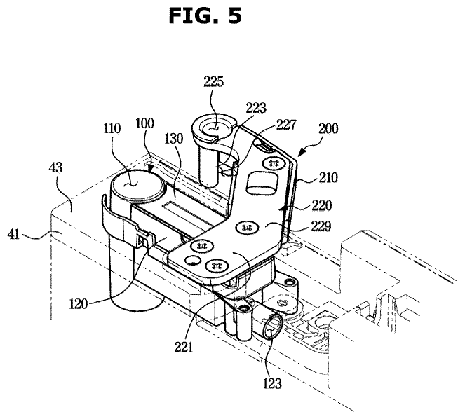

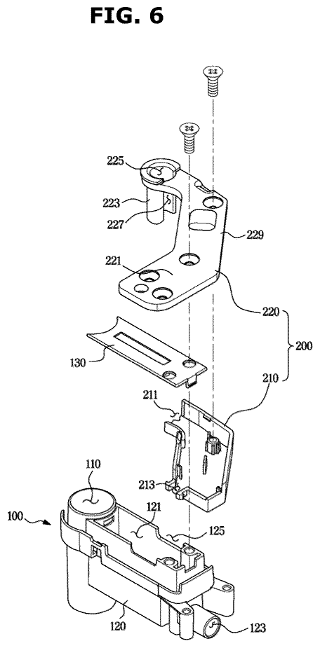

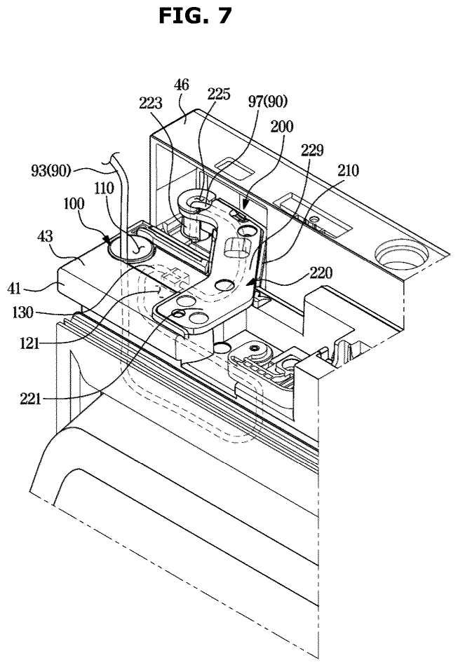

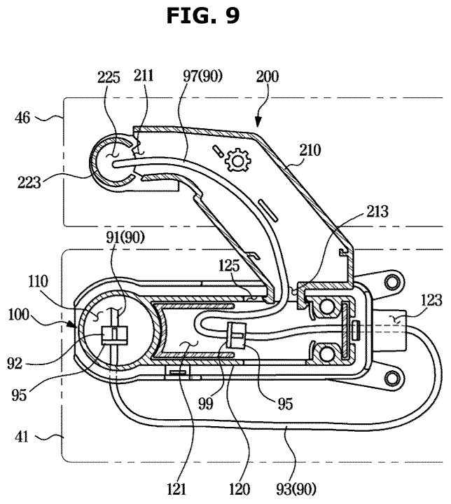

FIG. 4 is an exploded view illustrating a portion of the configuration of the refrigerator according to an embodiment. FIG. 5 is a view illustrating a hinge assembled to an inner door and a second hinge according to an embodiment. FIG. 6 is an exploded view illustrating the hinge and the second hinge according to an embodiment. FIG. 7 is a view illustrating a state in which a first electric wire and a second electric wire are connected in a connection space of the hinge assembled to the inner door according to an embodiment. FIG. 8 is a cross-sectional view illustrating a state in which the first electric wire and the second electric wire are connected in the connection space of the hinge assembled to the inner door according to an embodiment. FIG. 9 is a view illustrating a state in which an electric wire is connected as viewed from an upper portion of the door according to an embodiment.

As illustrated in FIGS. 4 to 9, the first hinge 80 may be coupled to an upper portion of the main body 10. The hinge 100, into which the first hinge shaft 83 of the first hinge 80 is rotatably inserted, may be assembled to the upper portion of the inner door 41. The hinge 100 may include a hinge hole 110 into which the first hinge shaft 83 is rotatably inserted. The inner door 41 may rotate about the first hinge shaft 83 by the first hinge shaft 83 inserted into the hinge hole 110.

The second hinge 200 may be coupled to the upper portion of the inner door 41. The rotation hole 47, into which the second hinge shaft 223 of the second hinge 200 is rotatably inserted, may be formed in the outer door 46. The outer door 46 may rotate about the second hinge shaft 223 by the second hinge shaft 223 inserted into the rotation hole 47.

A controller and/or a power supply device provided in the main body 10 may be electrically connected to the display device 70 (see FIG. 3) provided on the outer door 46 by an electric wire 90. The electric wire 90 may include a main body electric wire 91, one end of which is connected to the controller and/or the power supply device provided in the main body 10. The other end of the main body electric wire 91 may be guided through a first hollow portion 85 of the first hinge shaft 83, and connected to a first electric wire 93. The main body electric wire 91 and the first electric wire 93 may be connected by connecting a main body connector 92 of the main body electric wire 91 and a first connector 95 of the first electric wire 93. The main body electric wire 91 and the first electric wire 93 may be detachably connected by the main body connector 92 of the main body electric wire 91 and the first connector 95 of the first electric wire 93.

The electric wire 90 may include the first electric wire 93, one end of which is connected to the main body electric wire 91, and the other end of which is connected to a second electric wire 97. The first electric wire 93 and the second electric wire 97 may be connected by connecting the first connector 95 of the first electric wire 93 and a second connector 99 of the second electric wire 97. The first electric wire 93 may be detachably connected to the main body electric wire 91 and may be disposed to pass through the inner door 41. The first electric wire 93 connected to the main body electric wire 91 may be inserted into the first hollow portion 85 of the first hinge shaft 83 and guided by the hinge 100 assembled to the inner door 41.

The electric wire 90 may include the second electric wire 97, one end of which is connected to the first electric wire 93, and the other end of which is connected to the display device 70 (see FIG. 3). The second electric wire 97 and the first electric wire 93 may be connected by connecting the second connector 99 of the second electric wire 97 and the first connector 95 of the first electric wire 93. The second electric wire 97 may be detachably connected to the first electric wire 93 and may extend from the outer door 46 to the inner door 41. One end of the second electric wire 97 extending from the outer door 46 to the inner door 41 may extend to the inner door 41 through the rotation hole 47 formed in the outer door 46. One end of the second electric wire 97 extending to the inner door 41 may be guided by the second hinge 200 and connected to the first electric wire 93.

The hinge 100 may be assembled to an upper portion of the inner door 41. The inner door 41 may include an upper portion surface 43 that covers the upper portion of the inner door 41. The hinge 100 may be assembled to the upper portion surface 43 so that an upper portion of the hinge 100 is exposed to the outside by penetrating the upper portion surface 43 from a lower portion of the upper portion surface 43 of the inner door 41. That is, a portion of the upper portion of the hinge 100 may be exposed to the outside by penetrating the upper portion surface 43 of the inner door 41.

The hinge 100 may include the hinge hole 110 into which the first hinge shaft 83 of the first hinge 80 is rotatably inserted. The hinge hole 110 may be formed so that an upper portion thereof is open. A portion of the upper portion of the hinge hole 110 may be exposed to the outside by penetrating the upper portion surface 43 of the inner door 41. The hinge hole 110 may guide the first electric wire 93 connected to the main body electric wire 91. An insulation space 44 in which an insulation 15 is filled may be formed inside the inner door 41. The first electric wire 93 may be guided into the insulation space 44 of the inner door 41 by the hinge hole 110.

The hinge 100 may include a connection portion 120 integrally formed with the hinge hole 110. The connection portion 120 may be formed so that an upper portion thereof is open. The upper portion of the connection portion 120, which is open, may be exposed to the outside by penetrating the upper portion surface 43 of the inner door 41.

The connection portion 120 may include a connection space 121 formed therein so that the first electric wire 93 is connected to the second electric wire 97. The first connector 95 of the first electric wire 93 and the second connector 99 of the second electric wire 97 may be detachably connected in the connection space 121. Because the open upper portion of the connection portion 120 is exposed to the outside, the connection space 121 may be exposed to the outside. Because the first electric wire 93 and the second electric wire 97 are detachably connected in the connection space 121 that is exposed to the outside, connection and/or disconnection of the first electric wire 93 and the second electric wire 97 may be facilitated.

The connection portion 120 may include a guide hole 123 configured such that the first electric wire 93, guided into the insulation space 44, which is the interior of the inner door 41, by the hinge hole 110, is guided into the connection space 121 from the interior of the inner door 41. The hinge hole 110 may be formed at one side of the connection portion 120, and the guide hole 123 may be formed at the other side of the connection portion 120, which is opposite to the hinge hole 110. The first electric wire 93 guided into the connection space 121 by the guide hole 123 may be detachably connected to the second electric wire 97 in the connection space 121.

The connection portion 120 may include a communication opening 125 that communicates with a guide hinge 210 of the second hinge 200. The communication opening 125 of the connection portion 120 may communicate with the guide hinge 210, and the second electric wire 97 guided by the guide hinge 210 may be guided to the connection space 121 through the communication opening 125.

The hinge 100 may include a connection portion cover 130 that covers an upper portion of the open connection portion 120. The connection portion cover 130 may cover the upper portion of the connection space 121 exposed to the outside. When the first electric wire 93 and the second electric wire 97 are connected in the connection space 121 exposed to the outside, the connection portion cover 130 may be assembled to the upper portion of the connection space 121 to prevent the connection space 121 from being exposed to the outside. When the first electric wire 93 and the second electric wire 97 are to be disconnected, the assembled connection portion cover 130 may be removed to expose the connection space 121 to the outside, so that the first electric wire 93 and the second electric wire 97 may be easily disconnected.

As described above, because the hinge 100, which guides the first electric wire 93 connected to the main body electric wire 91 and passing through the inner door 41, to the connection space 121 connected to the second electric wire 97 connected to the outer door 46, is integrally formed, material costs may be reduced and the manufacturing process may be shortened.

The second hinge 200 may be coupled to the upper portion of the inner door 41 so that the outer door 46 is rotatably provided on the front surface of the inner door 41. The second hinge 200 may guide the second electric wire 97 connected to the display device 70 (see FIG. 3) of the outer door 46 to the connection space 121.

The second hinge 200 may include the guide hinge 210 that is coupled to the outer door 46 so as to be connected to the connection portion 120. The guide hinge 210 may be formed so that an upper portion thereof is open. The guide hinge 210 may guide the second electric wire 97 to the connection space 121. The guide hinge 210 may include a first communication portion 211 that communicates with a connection opening 227 of the second hinge shaft 223 to be described below. The guide hinge 210 may include a second communication portion 213 that communicates with the communication opening 125 of the connection portion 120. That is, the first communication portion 211 and the second communication portion 213 may be provided at both ends of the guide hinge 210, respectively. The first communication portion 211 and the second communication portion 213 provided at both ends of the guide hinge 210 may respectively communicate with the connection opening 227 of the second hinge shaft 223 and the communication opening 125 of the connection portion 120, so that the second electric wire 97 may be guided from the outer door 46 to the connection space 121 of the inner door 41.

The second hinge 200 may include a hinge cover 220 coupled to the upper portion of the inner door 41. The hinge cover 220 may cover an upper portion of the guide hinge 210. The hinge cover 220 may include a hinge coupling portion 221 that is coupled to the upper portion surface 43 of the inner door 41.

The hinge cover 220 may include the second hinge shaft 223 rotatably inserted into the rotation hole 47 formed in the outer door 46. The second hinge shaft 223 may include a second hollow portion 225. The second electric wire 97 extending to the inner door 41 through the rotation hole 47 formed in the outer door 46 may be inserted into the second hollow portion 225 of the second hinge shaft 223.

The second hinge shaft 223 may include the connection opening 227 that is formed such that a portion of a side surface of the second hinge shaft 223 is opened so that the second hollow portion 225 is connected to the guide hinge 210. The connection opening 227 may communicate with the first communication portion 211 of the guide hinge 210. The second electric wire 97 inserted into the second hollow portion 225 may be inserted into the guide hinge 210 through the connection opening 227. The second electric wire 97 inserted into the guide hinge 210 may be guided by the guide hinge 210 and be guided into the connection space 121 through the communication opening 125 communicated with the second communication portion 213.

The hinge cover 220 may include a hinge connection portion 229 extending from the hinge coupling portion 221 and connecting the hinge coupling portion 221 and the second hinge shaft 223. An open upper portion of the guide hinge 210 may be covered by the hinge connection portion 229.

According to an embodiment of the present disclosure, a refrigerator may include a main body 10 including a storage compartment 20, an inner door 41 rotatably provided on a front surface of the main body by a first hinge 80 coupled to the main body, an outer door 46 rotatably provided on a front surface of the inner door, a first electric wire 93 that is detachably connected to a main body electric wire 91 of the main body and is disposed to pass through the inner door, a second electric wire 97 that extends from the outer door to the inner door and is connected to the first electric wire, and a hinge 100 assembled to an upper portion of the inner door. The hinge 100 may include a hinge hole 110 into which a first hinge shaft 83 of the first hinge is rotatably inserted and that guides the first electric wire, and a connection portion 120 that is integrally formed with the hinge hole and forms a connection space 121 therein in which the first electric wire is connected to the second electric wire. According to the present disclosure, a connection space 121 in which an electric wire 90 connecting the display device 70 provided on the door 40 and the main body 10 is connected may be exposed to the outside of the door, so that connection and/or disconnection of the electric wire may be facilitated. A component for guiding the first electric wire 93, which is connected to the main body electric wire 91 and passes through the inner door 41, to the connection space 121 connected to the second electric wire 97 connected to the outer door 46, may be formed as the hinge 100, which is a single component, so that material costs may be reduced and the manufacturing process may be shortened.

The connection portion may include the guide hole 123 configured such that the first electric wire, guided into the inner door by the hinge hole, is guided to the connection space from the interior of the inner door. According to the present disclosure, the guide hole 123, which guides the first electric wire 93 to the connection space 121, is formed in the connection portion 120 that is integrally formed with the hinge hole 110, so that the first electric wire is guided by the hinge, which is a single component, thereby reducing material costs and shortening the manufacturing process.

The hinge hole may be formed on one side of the connection portion, and the guide hole may be formed on the other side of the connection portion opposite to the hinge hole.

The inner door may include the upper portion surface 43 that covers an upper portion of the inner door, and the hinge may be assembled to the upper portion surface so that an upper portion of the hinge is exposed to the outside by penetrating the upper portion surface from a lower portion of the upper portion surface. According to the present disclosure, because the upper portion of the hinge 100 is exposed to the outside by penetrating the upper portion surface 43 of the inner door, the connection space 121 is exposed to the outside, so that connection and/or disconnection of the first electric wire 93 and the second electric wire 97 may be facilitated.

The hinge may be formed such that upper portions of the hinge hole and the connection portion are open, and may further include the connection portion cover 130 that covers the open upper portion of the connection portion. According to the present disclosure, after the first electric wire 93 and the second electric wire 97 are connected and/or disconnected, the connection space 121 may be covered with the connection portion cover 130 so that exposure of the first electric wire 93 and the second electric wire 97 is minimized, thereby improving exterior quality.

The first hinge shaft may include the first hollow portion 85, and the first electric wire may be inserted into the first hollow portion and guided by the hinge hole.

The outer door may be rotatably provided on the front surface of the inner door by the second hinge 200.

The second hinge 200 may include the guide hinge 210 that is coupled to the outer door so as to be connected to the connection portion and guide the second electric wire to the connection space, and the hinge cover 220 that is coupled to the inner door to cover an upper portion of the guide hinge. According to the present disclosure, because the second electric wire 97 extending from the outer door 46 to the inner door 41 is guided to the connection space 121 of the hinge 100 by the second hinge 200, the second electric wire may be easily connected to and/or disconnected from the first electric wire 93.

The hinge cover may include the hinge coupling portion 221 coupled to the upper portion surface of the inner door, the second hinge shaft 223 rotatably inserted into the rotation hole 47 formed in the outer door, and the hinge connection portion 229 that extends from the hinge coupling portion and connects the hinge coupling portion and the second hinge shaft. According to the present disclosure, because the second electric wire 97 extending from the outer door 46 to the inner door 41 is guided to the connection space 121 of the hinge 100 by the second hinge 200, the second electric wire may be easily connected to and/or disconnected from the first electric wire 93. According to the present disclosure, the exposure of the second electric wire 97 may be minimized by the hinge cover 220, thereby improving exterior quality.

The second hinge shaft may include the second hollow portion 225, and the connection opening 227 formed such that a portion of a side surface of the second hinge shaft 223 is opened so that the second hollow portion is connected to the guide hinge. According to the present disclosure, the second hinge shaft 223 is connected to the guide hinge 210 by the connection opening 227, so that the second electric wire 97 may be easily guided.

The guide hinge may include the first communication portion 211 communicating with the connection opening, and the second communication portion 213 communicating with the connection portion. According to the present disclosure, the second electric wire 97 may be easily guided from the second hinge shaft 223 to the connection space 121 by the first communication portion 211 and the second communication portion 213 formed in the guide hinge 210.

The second electric wire inserted into the second hollow portion may be inserted into the guide hinge through the connection opening and the first communication portion, and the second electric wire guided by the guide hinge may be inserted into the connection space through the second communication portion and be connected to the first electric wire. According to the present disclosure, the second electric wire 97 may be easily guided from the interior of the guide hinge 210 to the connection space 121 through the connection opening 227 and the first communication portion 211.

The connection portion may be formed such that an upper portion thereof is open, and the connection space may be exposed to the outside. According to the present disclosure, the connection space 121 is exposed to the outside, so that connection and/or disconnection of the first electric wire 93 and the second electric wire 97 may be facilitated.

The outer door may be electrically connected to the inner door and the main body by connecting the first connector 95 of the first electric wire and the second connector 99 of the second electric wire in the connection space.

The outer door may be electrically disconnected from the inner door and the main body by separating the first connector and the second connector in the connection space.

A refrigerator according to an embodiment of the present disclosure may include a main body 10 including a storage compartment 20, an inner door 41 that is rotatably provided on a front surface of the main body, and includes a hinge 100 into which a first hinge shaft 83 of a first hinge 80 coupled to the main body is rotatably inserted, an outer door 46 that is rotatably provided on a front surface of the inner door by a second hinge 200 coupled to the inner door, a first electric wire 93 that is detachably connected to a main body electric wire 91 of the main body and disposed to pass through the inner door, and a second electric wire 97 that extends from the outer door to the inner door and is connected to the first electric wire. The hinge 100 may include a hinge hole 110 that is assembled to an upper portion of the inner door so that the first hinge shaft is rotatably inserted and that guides the first electric wire, and a connection portion 120 that is integrally formed with the hinge hole and forms therein a connection space 121 in which the first electric wire is connected to the second electric wire. The second hinge 200 may include a guide hinge 210 that is coupled to the outer door so as to be connected to the connection portion and that guides the second electric wire to the connection space, and a hinge cover 220 that is coupled to the inner door and covers an upper portion of the guide hinge. According to the present disclosure, a connection space 121 in which an electric wire 90 connecting the display device 70 provided on the door 40 and the main body 10 is connected may be exposed to the outside of the door, so that connection and/or disconnection of the electric wire may be facilitated. After the electric wire 90 connecting the display device 70 provided on the door 40 and the main body is connected, exposure of the electric wire may be minimized, so that exterior quality may be improved. A component for guiding the first electric wire 93, which is connected to the main body electric wire 91 and passes through the inner door 41, to the connection space 121 connected to the second electric wire 97 connected to the outer door 46, may be formed as the hinge 100, which is a single component, so that material costs may be reduced and the manufacturing process may be shortened.

An insulation space 44 in which an insulation 15 is filled may be formed inside the inner door, and the connection portion may include a guide hole 123 configured such that the first electric wire, which is guided to the insulation space by the hinge hole, is guided from the insulation space to the connection space. According to the present disclosure, the guide hole 123, which guides the first electric wire 93 to the connection space 121, is formed in the connection portion 120 that is integrally formed with the hinge hole 110, so that the first electric wire is guided by the hinge, which is a single component, thereby reducing material costs and shortening the manufacturing process.

The inner door may include the upper portion surface 43 that covers an upper portion of the insulation space, and the hinge may be assembled to the upper portion surface so that an upper portion of the hinge is exposed to the outside by penetrating the upper portion surface from a lower portion of the upper portion surface. According to the present disclosure, because the upper portion of the hinge 100 is exposed to the outside by penetrating the upper portion surface 43 of the inner door, the connection space 121 is exposed to the outside, so that connection and/or disconnection of the first electric wire 93 and the second electric wire 97 may be facilitated.

The connection portion may be formed such that an upper portion thereof is open, so that the connection space is exposed to the outside, and when the first electric wire and the second electric wire are connected in the connection space, an upper portion of the connection space exposed to the outside may be covered by the connection portion cover 130. According to the present disclosure, after the first electric wire 93 and the second electric wire 97 are connected and/or disconnected, the connection space 121 may be covered with the connection portion cover 130 so that exposure of the first electric wire 93 and the second electric wire 97 is minimized, thereby improving exterior quality.

The hinge cover may include the hinge coupling portion 221 coupled to the upper portion surface 43 of the inner door, the second hinge shaft 223 rotatably inserted into the rotation hole 47 formed in the outer door, and the hinge connection portion 229 that extends from the hinge coupling portion and connects the hinge coupling portion and the second hinge shaft. According to the present disclosure, because the second electric wire 97 extending from the outer door 46 to the inner door 41 is guided to the connection space 121 of the hinge 100 by the second hinge 200, the second electric wire may be easily connected to and/or disconnected from the first electric wire 93. According to the present disclosure, the exposure of the second electric wire 97 may be minimized by the hinge cover 220, thereby improving exterior quality.

According to embodiments of the present disclosure, a connection structure of an electric wire connecting a display device provided on a door and a main body may be improved.

According to embodiments of the present disclosure, a connection space in which an electric wire connecting a display device provided on a door and a main body is connected may be exposed to the outside of the door, so that connection and/or disconnection of the electric wire may be facilitated.

According to embodiments of the present disclosure, after an electric wire connecting a display device provided on a door and a main body is connected, exposure of the electric wire may be minimized, so that exterior quality may be improved.

According to embodiments of the present disclosure, a component for guiding a first electric wire, which is connected to a main body electric wire and passes through an inner door, to a connection space connected to a second electric wire connected to an outer door, may be formed as a hinge, which is a single component, so that material costs may be reduced and the manufacturing process may be shortened.

The effects obtained by the present disclosure are not limited to the aforementioned effects, and other effects, which are not mentioned above, will be clearly understood by those skilled in the art from the following description.

In the above, the refrigerator has been described with reference to the accompanying drawings, focusing on specific shapes and directions, but various modifications and changes may be made by those skilled in the art, and such modifications and changes should be interpreted as being included in the scope of rights of the present disclosure.

1. A refrigerator, comprising:
a main body including a storage compartment;
an inner door to be provided on a front surface of the main body and while provided on the front surface, the inner door is rotatable about a hinge coupled to the main body;
an outer door rotatable relative to a front surface of the inner door;
a first electric wire, connectable to a main body electric wire of the main body, to pass through the inner door;
a second electric wire, connectable to the first electric wire, such that while the second electric wire is connected to the first electric wire, the second electric wire extends from the outer door to the inner door; and
a hinge assembly to be arranged an upper portion of the inner door,
wherein the hinge assembly comprises:
a hinge hole into which a hinge shaft of the hinge is rotatably insertable and which guides the first electric wire; and
a connection portion integrally formed with the hinge hole and forming a connection space in which the first electric wire is connected to the second electric wire.

2. The refrigerator of claim 1,
wherein the connection portion includes a guide hole configured such that the first electric wire, which is guided into the inner door by the hinge hole, is guided from an interior of the inner door to the connection space.

3. The refrigerator of claim 2,
wherein the hinge hole is formed on one side of the connection portion, and the guide hole is formed on an other side of the connection portion, opposite to the hinge hole.

4. The refrigerator of claim 1,
wherein the inner door includes an upper portion surface that covers the upper portion of the inner door, and the hinge assembly is arranged to the upper portion surface such that an upper portion of the hinge assembly is exposed by penetrating the upper portion surface from a lower portion of the upper portion surface.

5. The refrigerator of claim 4,
wherein the hinge assembly is formed such that upper portions of the hinge hole and the connection portion are open, and
wherein the hinge assembly further comprises:
a connection portion cover that covers the upper portion of the connection portion that is open.

6. The refrigerator of claim 1,
wherein the hinge shaft includes a first hollow portion, and the first electric wire is inserted into the first hollow portion and guided by the hinge hole.

7. The refrigerator of claim 1, wherein the hinge is a first hinge and the refrigerator includes a second hinge,
wherein the outer door is rotatably provided on the front surface of the inner door by the second hinge.

8. The refrigerator of claim 7,
wherein the second hinge includes:
a guide hinge coupled to the outer door so as to be connected to the connection portion and to guide the second electric wire to the connection space; and
a hinge cover coupled to the inner door to cover an upper portion of the guide hinge.

9. The refrigerator of claim 8, wherein the hinge shaft is a first hinge shaft, and
wherein the hinge cover includes:
a hinge coupling portion coupled to an upper portion surface of the inner door;
a second hinge shaft rotatably inserted into a rotation hole formed in the outer door; and
a hinge connection portion extending from the hinge coupling portion and connecting the hinge coupling portion and the second hinge shaft.

10. The refrigerator of claim 9,
wherein the second hinge shaft includes:
a second hollow portion; and
a connection opening formed such that a portion of a side surface of the second hinge shaft is opened so that the second hollow portion is connected to the guide hinge.

11. The refrigerator of claim 10,
wherein the guide hinge includes:
a first communication portion communicating with the connection opening; and
a second communication portion communicating with the connection portion.

12. The refrigerator of claim 11,
wherein the second electric wire inserted into the second hollow portion is inserted into the guide hinge through the connection opening and the first communication portion,
and the second electric wire guided by the guide hinge is inserted into the connection space through the second communication portion and connected to the first electric wire.

13. The refrigerator of claim 1,
wherein the connection portion is formed such that an upper portion thereof is open, and the connection space is exposed.

14. The refrigerator of claim 13,
wherein the outer door is electrically connected to the inner door and the main body by connecting a first connector of the first electric wire and a second connector of the second electric wire in the connection space.

15. The refrigerator of claim 14,
wherein the outer door is electrically disconnected from the inner door and the main body by separating the first connector and the second connector in the connection space.
